(19) United States
(12) Patent Application Publication
(10) Pub. No.: US 2020/0279489 A1
(43) Pub. Date: Sep. 3, 2020

(54) VEHICLE LOCATION DETECTION

(71) Applicant: INTERNATIONAL BUSINESS MACHINES CORPORATION, ARMONK, NY (US)

(72) Inventors: Tao Liu, Dublin, OH (US); Hong Bing Zhang, BeijIng (CN); Qiang He, Ningbo (CN); Yan Fen Liu, Tianjin (CN)

(21) Appl. No.: 16/288,151

(22) Filed: Feb. 28, 2019

(51) Int. Cl. G08G 1/00; G08G 1/017; G06K 9/00; G06T 7/70

(52) U.S. Cl. CPC G08G 1/20; G08G 1/017; G06T 2207/30264; G06T 7/70; G06K 9/00791

(57) ABSTRACT

An embodiment of the invention may include a method, computer program product and computer system for vehicle location detection. The method, computer program product and computer system may include a computing device which may receive image data from an imaging device associated with a vehicle and sensor data from a vehicle sensor device associated with the vehicle. The computing device may detect the vehicle has entered a parking scene based on the received image data. The computing device may detect the surroundings of the vehicle using the imaging device. The computing device may determine the vehicle is parking based on the received sensor data. The computing device may identify a parking location of the vehicle based on the received image data, receive image data and detect the surroundings associated with the identified parking location. The computing device may generate a notification to a user associated with the vehicle.

### BACKGROUND

The present invention relates generally to a method, system, and computer program for vehicle location detection. More particularly, the present invention relates to a method, system, and computer program for determining the location of a parked vehicle using video and vehicle sensor analysis.

Locating a parked vehicle can be a frustrating and time-consuming task, especially if the parking area is big and complex. Further complicating the location of a parked vehicle is the amount of time that has passed since the vehicle was parked. For example, it can be hard to remember exactly where a vehicle is parked at a sports stadium, which can hold tens of thousands of cars, after attending a game for several hours. Currently, drivers need to manually record the parking location of their vehicle and remember how to get there. There are also ticketing systems currently in use in some locations which issue parking tickets/cards identifying the parking location. Further, there are camera systems that may be installed in and around a parking structure which capture the position of the parked vehicle and the license plate number and based on picture analysis can tell the driver where the vehicle is parked.

### BRIEF SUMMARY

An embodiment of the invention may include a method, computer program product and computer system for vehicle location detection. The method, computer program product and computer system may include computing device which may receive image data from an imaging device associated with a vehicle and sensor data from a vehicle sensor device associated with the vehicle. The computing device may detect the vehicle has entered a parking scene based on the received image data. The computing device may detect the surroundings of the vehicle using the imaging device associated with the vehicle. The computing device may determine the vehicle is parking based on the received sensor data associated with the vehicle. The computing device may identify a parking location of the vehicle based on the received image data associated with the vehicle, receive image data associated with the identified parking location of the vehicle from an imaging device associated with a vehicle and detect the surroundings of the identified parking location. The computing device may generate a notification to a user associated with the vehicle, wherein the notification identifies the parking location of the vehicle.

### BRIEF DESCRIPTION OF THE DRAWINGS

FIG. 1a illustrates a system for vehicle location detection, in accordance with an embodiment of the invention.

FIG. 1b illustrates example operating modules of the vehicle location detection program of FIG. 1a.

FIG. 2 is a flowchart illustrating an example method of the vehicle location detection in accordance with an embodiment of the invention.

FIG. 3 is a block diagram depicting the hardware components of the vehicle location detection system of FIG. 1, in accordance with an embodiment of the invention.

FIG. 4 illustrates a cloud computing environment, in accordance with an embodiment of the invention.

FIG. 5 illustrates a set of functional abstraction layers provided by the cloud computing environment of FIG. 4, in accordance with an embodiment of the invention.

### DETAILED DESCRIPTION

Embodiments of the present invention will now be described in detail with reference to the accompanying Figures.

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention provide a method, computer program, and computer system for determining the location of a parked vehicle using video analysis. More particularly, embodiments of the present invention utilize video captured from a vehicle to determine a parking location of the vehicle. Current technology does not utilize video captured from a vehicle to determine a parking location of the vehicle. Currently, existing systems utilize video captured from cameras separate from the vehicle, such as, parking lot cameras and street cameras. However, such camera systems have a prohibitively high costs as such systems need to cover the entire parking structure and every single individual parking space within the parking structure. Also, existing camera systems present privacy issues as the system may be accessible by anyone and thus one vehicle can be searched by anyone accessing the system. Accordingly, a need exists for alternative systems and methods for determining parking locations of vehicles and providing the parking location to a user. Embodiments of the present invention provide a means for utilizing vehicle sensor devices and imaging devices associated with a vehicle to detect a parking location of a vehicle and transmit that location to a user.

Reference will now be made in detail to the embodiments of the present invention, examples of which are illustrated in the accompanying drawings, wherein like reference numerals refer to like elements throughout. Embodiments of the invention are generally directed to a system for determining the location of a parked vehicle using video and vehicle sensor analysis.

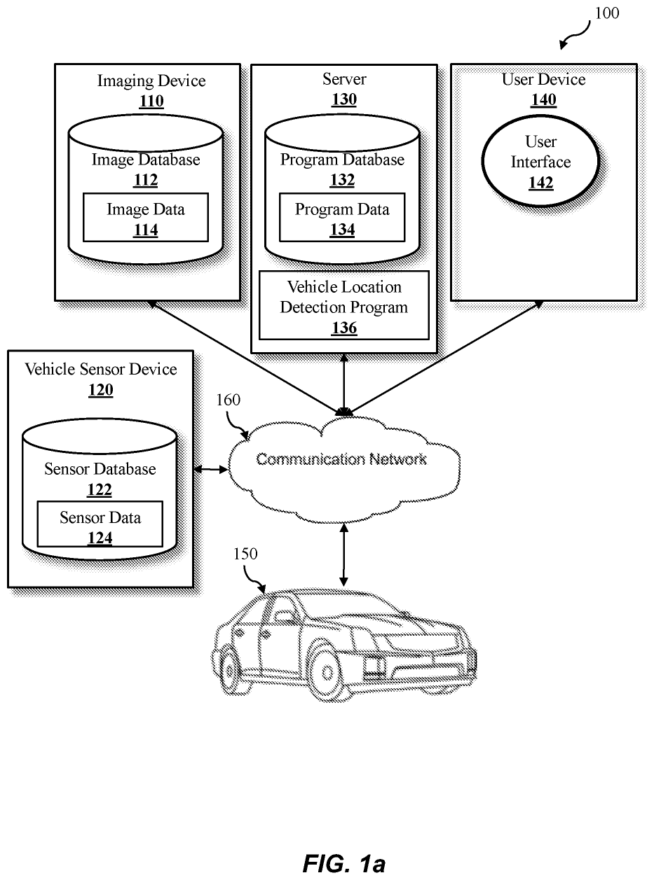

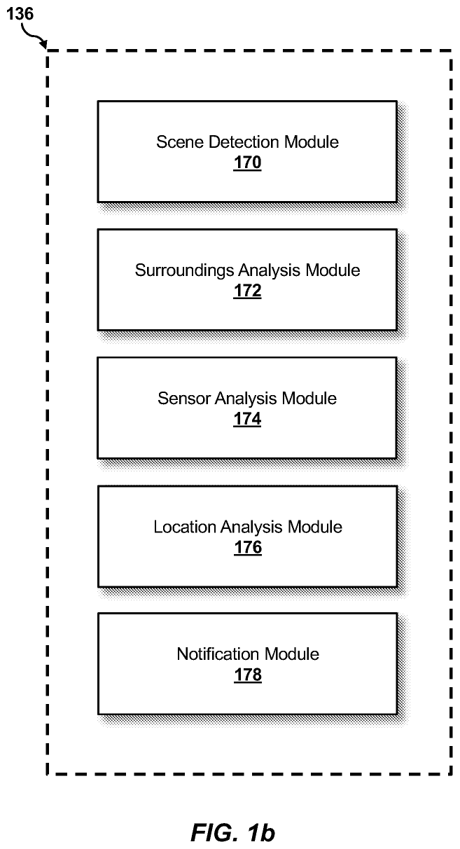

FIG. 1 illustrates a vehicle location detection system 100, in accordance with an embodiment of the invention. In an example embodiment, vehicle location detection system 100 includes an imaging device 110, a vehicle sensor device 120, server 130, user device 140, and vehicle 150, interconnected via network 160.

In the example embodiment, the network 160 is the Internet, representing a worldwide collection of networks and gateways to support communications between devices connected to the Internet. The network 160 may include, for example, wired, wireless or fiber optic connections. In other embodiments, the network 160 may be implemented as an intranet, a local area network (LAN), or a wide area network (WAN). In general, the network 160 can be any combination of connections and protocols that will support communications between the imaging device 110, a vehicle sensor device 120, server 130, user device 140, and vehicle 150.

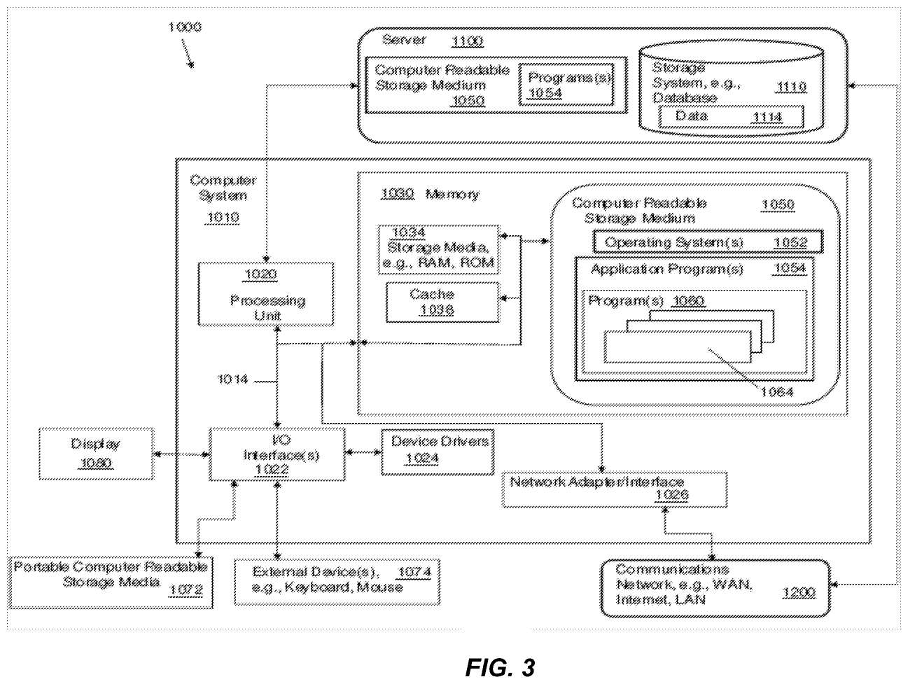

The imaging device 110 may include the image database 112. The imaging device 110 may be any device capable of capturing the image data 114. The image data 114 may include, but is not limited to, visual, audio, and/or textual data. For example, the imaging device 110 may capture video or images, or both, of the vehicle 150 and the surroundings of the vehicle 150. The video and images captured by the imaging device 110 may also contain textual data, such as, but not limited to, road signs, signs, billboards, markings, etc. In the example embodiment, the imaging device 110 may be a camera, a computer, a tablet, a thin client, a cellphone, or any other device capable of capturing, storing, and/or compiling visual, audio, and/or textual data and sending that visual, audio, and/or textual data to and from other computing devices, such as the server 130, the user device 140, and the vehicle 150 via the network 160. The imaging device 110 may be associated with the vehicle 150. For example, the imaging device 110 may be, but not limited to, built in to the vehicle 150, resident in the vehicle 150, physically attached to vehicle 150, and/or located within the vehicle 150. Thus, the imaging device 110 is associated with the vehicle 150 and provides the image data 114 from the vehicle 150. The imaging device 110 is described in more detail with reference to FIG. 3.

The image database 112 may store the image data 114, i.e. the visual, audio, and/or textual data, captured by the imaging device 110. The image database 112 may be any storage media capable of storing data capable of storing data, such as, but not limited to, storage media resident in the imaging device 110 and/or removeable storage media. For example, the image database 112 may be, but is not limited to, a hard drive, a solid stated drive, a USB drive, or a memory card, etc. The image database 112 is described in more detail above and with reference to FIG. 3.

The vehicle sensor device 120 may include the sensor database 122. The vehicle sensor device 120 may be any device capable of capturing the sensor data 124. The sensor data 124 may include, but is not limited to, vehicle speed, vehicle acceleration, vehicle braking, vehicle direction, vehicle gear, etc. For example, but not limited to, the vehicle sensor device 120 may detect the speed of the vehicle 150, the direction the vehicle 150 is travelling, whether the vehicle 150 is stopped, and what gear the vehicle 150 is in, e.g. park, reverse, or drive, etc. In the example embodiment, the vehicle sensor device 120 may be an Internet of Things (IoT) device, a global positioning system (GPS) device, a radar system device, a light detection and ranging (LIDAR) system device, or any other device capable of capturing, storing, and/or compiling the sensor data 124 and sending the sensor data 124 to and from other computing devices, such as the server 130, the user device 140, and the vehicle 150 via the network 160. The vehicle sensor device 120 may be, for example, but not limited to, built in to the vehicle 150, resident in the vehicle 150, physically attached to vehicle 150, and/or located within the vehicle 150. While only a single vehicle sensor device 120 is illustrated, the vehicle location detection system 100 may include one or more vehicle sensor devices. The vehicle sensor device 120 is described in more detail with reference to FIG. 3.

The sensor database 122 may store the sensor data 124. The sensor database 122 may be any storage media capable of storing data capable of storing data, such as, but not limited to, storage media resident in the vehicle sensor device 120 and/or removeable storage media. For example, the sensor database 122 may be, but is not limited to, a hard drive, a solid stated drive, a

USB drive, or a memory card, etc. The sensor database 122 is described in more detail above and with reference to FIG. 3.

The server 130 may include the program database 132 and the vehicle location detection program 136. In the example embodiment, the server 130 may be a desktop computer, a notebook, a laptop computer, a tablet computer, a thin client, or any other electronic device or computing system capable of storing compiling and organizing audio, visual, or textual content and receiving and sending that content to and from other computing devices, such as the imaging device 110, the vehicle sensor device 120, the user device 140, and the vehicle 150 via network 160. In some embodiments, the server 130 includes a collection of devices, or data sources, in order to collect the program data 134. The server 130 is described in more detail with reference to FIG. 3.

The program database 132 may store the program data 134. The program database 132 may be any storage media capable of storing data capable of storing data, such as, but not limited to, storage media resident in the server 130 and/or removeable storage media. For example, the program database 132 may be, but is not limited to, a hard drive, a solid stated drive, a USB drive, or a memory card, etc. The program database 132 is described in more detail above and with reference to FIG. 3.

The program data 134 may be a collection of audiovisual content including, but not limited to, audio, visual, and textual content. The program data 134 may be, for example, the image data 114 and the sensor data 124 received and/or collected from the imaging device 110 and the vehicle sensor device 120. Further, the program data 134 may include user data such as, but not limited to, a user's identification, a user's phone number, a user's address, a user's preferences, e.g. contact preferences, and a list of the user device 140 associated with a user, etc. The program data 134 is located on the server 130 and can be accessed via the network 160. In accordance with an embodiment of the invention, the program data 134 may be located on one or a plurality of servers 130.

The vehicle location detection program 136 is a program capable of detecting when the vehicle 150 is parking, determining the parked location of the vehicle 150, and sending that location to a user on the user device 140. The vehicle location detection program 136 may receive the image data 114 and the sensor data 124, which may be received and/or collected by the server 130 and stored as the program data 134 in the program database 132. The vehicle location detection program 136 is described in more detail below with reference to FIG. 1b.

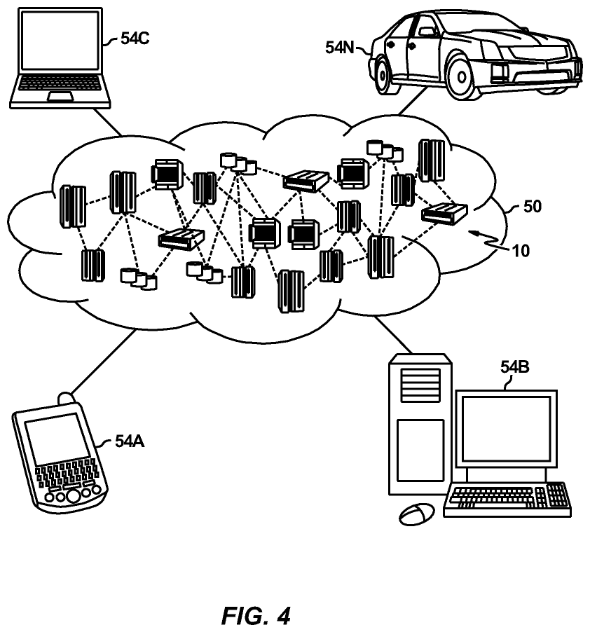

The user device 140 may include the user interface 142. In the example embodiment, the user device 140 may be a cellphone, desktop computer, a notebook, a laptop computer, a tablet computer, a thin client, or any other electronic device or computing system capable of storing compiling and organizing audio, visual, or textual content and receiving and sending that content to and from other computing devices, such as the imaging device 110, the vehicle sensor device 120, the server 130, and the vehicle 150 via the network 160. While only a single user device 140 is depicted, it can be appreciated that any number of user devices may be part of the vehicle location detection system 100. In some embodiments, the user device 140 includes a collection of devices or data sources. The user device 140 is described in more detail with reference to FIG. 4.

The user interface 142 includes components used to receive input from a user on the user device 140 and transmit the input to the vehicle location detection program 136 residing on server 130, or conversely to receive information from the vehicle location detection program 136 and display the information to the user on user device 140. In an example embodiment, the user interface 142 uses a combination of technologies and devices, such as device drivers, to provide a platform to enable users of the user device 140 to interact with the vehicle location detection program 136. In the example embodiment, the user interface 142 receives input, such as but not limited to, textual, visual, or audio input received from a physical input device, such as but not limited to, a keypad and/or a microphone.

The vehicle 150 may be any vehicle including, but not limited to, motorized and non-motorized vehicles. The vehicle 150 may be, for example, but not limited to, a passenger car, a motorcycle, a commercial vehicle, a boat, a bicycle or any other vehicle capable of communicating with the imaging device 110, vehicle sensor device 120, the server 130, and the user device 140 via the network 160. In one embodiment of the invention the imaging device 110 and/or the vehicle sensor device 120 may be hardwired into the vehicle 150 and communicate with the vehicle 150 via the network 160. In yet another embodiment of the invention, the imaging device 110 and/or the vehicle sensor device 120 may be separate devices which communicate with the vehicle 150 via the network 160. Thus, the imaging device 110 and/or the vehicle sensor device 120 is associated with the vehicle 150 and provides data from the vehicle 150.

FIG. 1b illustrates example modules of the vehicle location detection program 136. In an example embodiment, the vehicle location detection program 136 may include five modules: scene detection module 170, surroundings analysis module 172, sensor analysis module 174, location analysis module 176, and notification module 178.

The scene detection module 170 receives the image data 114 stored as the program data 134 from the program database 132. The scene detection module 170 analyzes the image data 114 which is captured from the imaging device 110 to identify the type of location of the vehicle 150. In an embodiment of the invention, the scene detection module 170 may analyze the image data 114 to determine if the vehicle 150 is in a parking location, e.g. a parking lot, a parking garage, street parking, etc., or on the road, e.g. actively driving. The scene detection module 170 may utilize visual recognition technology to determine the type of location of the vehicle 150. For example, the visual recognition technology may be, but not limited to, a trained parking scene recognition model. The trained parking scene recognition model may be generated using neural networks, including, but not limited to, deep convolutional neural networks, and deep recurrent neural networks. Deep convolutional neural networks are a class of deep, feed-forward artificial neural networks consisting of an input layer, an output layer, and multiple hidden layers used to analyze images. Deep recurrent neural networks are artificial neural networks wherein the connections between the nodes of the network form a directed graph along a sequence used for analyzing linguistic data. The scene detection module 170 may input the received image data 114 into the convolutional neural networks to generate the trained parking scene recognition model. The trained parking scene recognition model determines if the vehicle 150 is in a parking scene or not.

The surroundings analysis module 172 receives the program data 134 from the program database 132. The surroundings analysis module 172 analyzes the program data 134 to detect objects on the way to the parking position of the vehicle 150, such as, for example, after entering the parking location. The surroundings analysis module 172 analyzes the program data 134 after the scene detection module 170 determines the vehicle 150 has entered a parking scene. For example, the surroundings analysis module 172 may analyze the image data 114 stored as program data 134 to detect objects on the way and the parking position of the vehicle 150 such as, but not limited to, advertisements, parking garage pillars, elevators, store fronts, lights, trees, or any unique object on the way and the parking position of the vehicle 150. The surroundings analysis module 172 may utilize object recognition technology to detect objects on the way and the parking position of the vehicle 150. For example, the object recognition technology may be, but not limited to, a trained object detection model. The trained object detection model may be generated using neural networks, including, but not limited to, deep convolutional neural networks, and deep recurrent neural networks. Deep convolutional neural networks are a class of deep, feed-forward artificial neural networks consisting of an input layer, an output layer, and multiple hidden layers used to analyze images. Deep recurrent neural networks are artificial neural networks wherein the connections between the nodes of the network form a directed graph along a sequence used for analyzing linguistic data. The surroundings analysis module 172 may input the program data 134 into the convolutional neural networks to generate the trained object detection model. The trained object detection model detects unique objects surrounding the parking location of the vehicle 150.

The sensor analysis module 174 receives the sensor data 124 stored as the program data 134 from the program database 132. The sensor analysis module 174 analyzes the sensor data 124 which is captured from the vehicle sensor device 120 to determine if the vehicle 150 is parking. For example, the sensor analysis module 174 may analyze the sensor data 124 to determine vehicle speed variation and identify vehicle events of the vehicle 150 such as, but not limited to, specific patterns for parking, e.g., speed reduced from normal driving speed, vehicle gear, e.g. reverse, drive, or park, and vehicle stoppage.

The location analysis module 176 receives the program data 134 from the program database 132. The location analysis module 176 correlates the output of the scene detection module 170, the surroundings analysis module 172, and the sensor analysis module 174 to identify the parking location of the vehicle 150. For example, the location analysis module 176 may correlate the detection of a parking scene by the scene detection module 170 with the objects detected by the surroundings analysis module 172 and the detection of a parking event by the sensor analysis module 174. Further, the location analysis module 176 may receive the image data 114 stored as the program data 134 to further analyze the actual parking location of the vehicle 150. For example, the location analysis module 176 may analyze any visual and/or textual data immediately surrounding the actual parking location of the vehicle 150 within the image data 114 such as, but not limited to, words and numbers, etc. The visual and/or textual data immediately surrounding the actual parking location of the vehicle 150 within the image data 114 may include, but is not limited to, a parking spot identifier, e.g. a space number, parking lot area identifier, a parking garage level, etc. The location analysis module 176 may utilize optical character recognition (OCR) to analyze the image data 114. The location analysis module 176 may also utilize visual and/or object recognition technology to further analyze the actual parking location of the vehicle 150 as described above with reference to the scene detection module 170 and the surroundings analysis module 172. In an embodiment of the invention, the location analysis module 176 may also collect video from the image data 114 of the parking location.

The notification module 178 generates a notification of the parking location of the vehicle 150 determined by the location analysis module 176 to a user on the user device 140 via the user interface 142. The notification may include, but is not limited to, the determined parking location of the vehicle 150, e.g. 2^{nd} floor of parking garage space 223, information of the surroundings of the determined parking location of the vehicle 150, e.g. near the elevator, image data of the determined parking location of the vehicle 150, e.g. a video or picture of the parking location captured by the imaging device 110. The notification module 178 may send a notification to a user on the user device 140 based on user preferences which are stored in the program data 134 on the program database 132. The user may enter user preferences using the user device 140 via the user interface 142. User preferences may include, but are not limited to, a list of user devices associated with the user, frequency of notification, and what parking location information to include in a notification. While only a single user device 140 is depicted, the notification module 178 may send a notification to one or more user devices 140 depending on the user preferences.

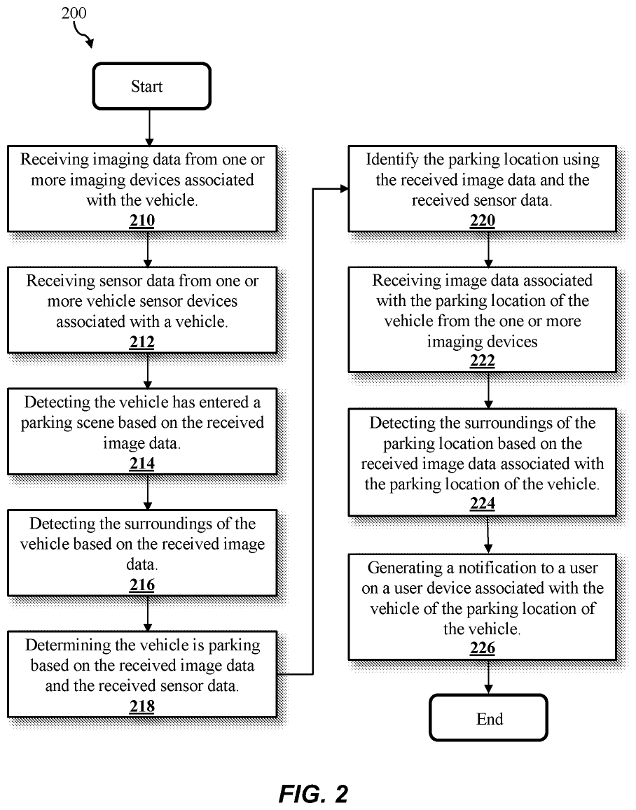

Referring to FIG. 2, a method 200 for vehicle location detection is depicted, in accordance with an embodiment of the present invention.

Referring to block 210, the vehicle location detection program 136 receives the image data 114 from the imaging device 110. Image data retrieval is described in more detail above with reference to FIG. 1b.

Referring to block 212, the vehicle location detection program 136 receives the sensor data 124 from the vehicle sensor device 120. Sensor data retrieval is described in more detail above with reference to FIG. 1b.

Referring to block 214, the scene detection module 170 detects the vehicle 150 has entered a parking scene based on the received the image data 114 stored as the program data 134 from the program database 132. Parking scene detection is described in more detail above with reference to the scene detection module 170.

Referring to block 216, the surroundings analysis module 172 detects objects on the way to the parking position of the vehicle 150 based on the image data 114 stored as program data 134. Surroundings analysis is described in more detail above with reference to the surroundings analysis module 172.

Referring to block 218, the sensor analysis module 174 determines if the vehicle 150 is parking based on the sensor data 124 which is captured from the vehicle sensor device 120 and stored as the program data 134. Sensor data analysis is described in more detail above with reference to the sensor analysis module 174.

Referring to block 220, the location analysis module 176 identifies the parking location of the vehicle 150 by correlating the output of the scene detection module 170, the surroundings analysis module 172, and the sensor analysis module 174. Parking location identification is described in more detail above with reference to the location analysis module 176.

Referring to block 222, the location analysis module 176 receives the image data 114 associated with the parking location of the vehicle 150 to further analyze the actual parking location of the vehicle 150. Parking location image data retrieval is described in more detail above with reference to the location analysis module 176.

Referring to block 224, the location analysis module 176 detects the surroundings of the parking location of the vehicle 150 based on the received image data 114 associated the parking location of the vehicle 150. Parking location surroundings detection is described in more detail above with reference to the location analysis module 176.

Referring to block 226, the notification module 178 generates a notification of the parking location of the vehicle 150 determined by the location analysis module 176 to a user on the user device 140 via the user interface 142. Notification generation is described in more detail above with reference to the notification module 178.

Referring to FIG. 3, a system 1000 includes a computer system or computer 1010 shown in the form of a generic computing device. The method 200 for example, may be embodied in a program(s) 1060 (FIG. 3) embodied on a computer readable storage device, for example, generally referred to as memory 1030 and more specifically, computer readable storage medium 1050 as shown in FIG. 3. For example, memory 1030 can include storage media 1034 such as RAM (Random Access Memory) or ROM (Read Only Memory), and cache memory 1038. The program 1060 is executable by the processing unit or processor 1020 of the computer system 1010 (to execute program steps, code, or program code). Additional data storage may also be embodied as a database 1110 which can include data 1114. The computer system 1010 and the program 1060 shown in FIG. 3 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in FIG. 3 as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, as shown in FIG. 3, the system 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media 1034 in the form of volatile memory, such as random access memory (RAM), and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention. As such, the computing device in FIG. 4 becomes specifically configured to implement mechanisms of the illustrative embodiments and specifically configured to perform the operations and generated the outputs of described herein for determining a route based on a user's preferred environmental experiences.

The methods 200 (FIG. 2), for example, may be embodied in one or more computer programs, generically referred to as a program(s) 1060 and can be stored in memory 1030 in the computer readable storage medium 1050. The program 1060 can include program modules 1064. The program modules 1064 can generally carry out functions and/or methodologies of embodiments of the invention as described herein. For example, the program modules 1064 can include the modules 170-178 described above with reference to Figure lb. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications.

The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

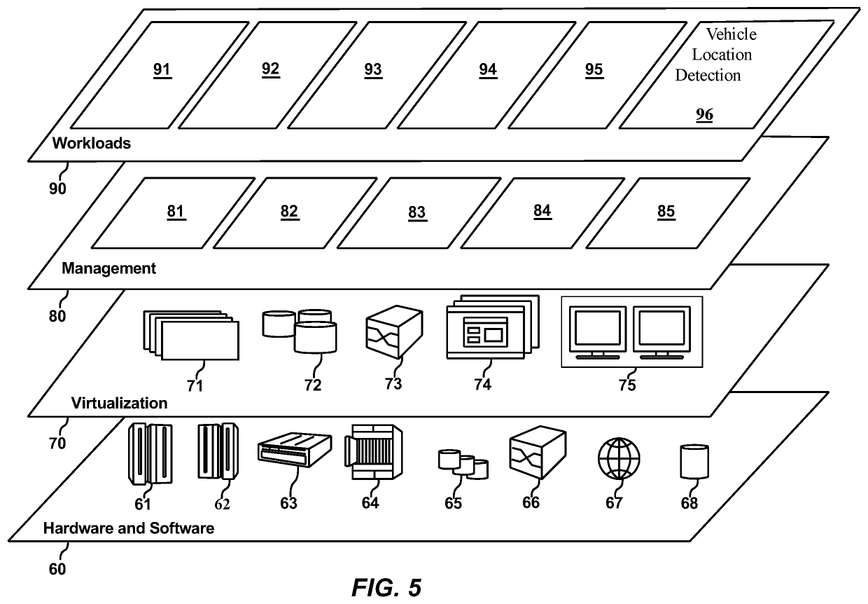

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and vehicle location detection 96.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

What is claimed is:

1. A method for vehicle location detection, the method comprising:
receiving, by a computing device, image data from an imaging device associated with a vehicle;
receiving, by the computing device, sensor data from a vehicle sensor device associated with the vehicle; and
detecting, by the computing device, the vehicle has entered a parking scene based on the received image data.

2. A method as in claim 1, wherein detecting, by the computing device, the vehicle has entered a parking scene based on the received image data is determined using a neural network.

3. A method as in claim 1, wherein the imaging device captures the image data from the vehicle.

4. A method as in claim 1, wherein detecting, by the computing device, the vehicle has entered a parking scene based on the received image data further comprises:
detecting, by the computing device, surroundings of the vehicle using the imaging device associated with the vehicle.

5. The method as in claim 1, further comprising:
determining, by the computing device, the vehicle is parking based on the received sensor data associated with the vehicle.

6. A method as in claim 5, further comprising:
identifying, by the computing device, a parking location of the vehicle based on the received image data associated with the vehicle.

7. A method as in claim 6, further comprising:
receiving, by a computing device, image data associated with the identified parking location of the vehicle from an imaging device associated with a vehicle; and
detecting, by the computing device, surroundings of the identified parking location of the vehicle using the imaging device associated with the vehicle.

8. A method as in claim 7, further comprising:
generating, by the computing device, a notification to a user associated with the vehicle, wherein the notification identifies the parking location of the vehicle.

9. A computer program product for vehicle location detection, the computer program product comprising:
a computer-readable storage medium having program instructions embodied therewith, wherein the computer readable storage medium is not a transitory signal per se, the program instructions comprising:
program instructions to receive, by a computing device, image data from an imaging device associated with a vehicle;
program instructions to receive, by the computing device, sensor data from a vehicle sensor device associated with the vehicle; and
program instructions to detect, by the computing device, the vehicle has entered a parking scene based on the received image data.

10. A computer program product as in claim 9, wherein program instructions to detect, by the computing device, the vehicle has entered a parking scene based on the received image data is determined using a neural network.

11. A computer program product as in claim 9, wherein the imaging device captures the image data from the vehicle.

12. A computer program product as in claim 9, wherein detecting, by the computing device, the vehicle has entered a parking scene based on the received image data further comprises:
program instructions to detect, by the computing device, surroundings of the vehicle using the imaging device associated with the vehicle.

13. A computer program product as in claim 9, further comprising:
program instructions to determine, by the computing device, the vehicle is parking based on the received sensor data associated with the vehicle;
program instructions to identify, by the computing device, a parking location of the vehicle based on the received image data associated with the vehicle.

14. A computer program product as in claim 13, further comprising:
program instructions to receive, by a computing device, image data associated with the identified parking location of the vehicle from an imaging device associated with a vehicle;
program instructions to detect, by the computing device, surroundings of the identified parking location of the vehicle using the imaging device associated with the vehicle; and
program instructions to generate, by the computing device, a notification to a user associated with the vehicle, wherein the notification identifies the parking location of the vehicle.

15. A computer system for vehicle location detection, the system comprising:
one or more computer processors, one or more computer-readable storage media, and program instructions stored on one or more of the computer-readable storage media for execution by at least one of the one or more processors, the program instructions comprising:
program instructions to program instructions to receive, by a computing device, image data from an imaging device associated with a vehicle;
program instructions to receive, by the computing device, sensor data from a vehicle sensor device associated with the vehicle; and
program instructions to detect, by the computing device, the vehicle has entered a parking scene based on the received image data.

16. A computer system as in claim 15, wherein program instructions to detect, by the computing device, the vehicle has entered a parking scene based on the received image data is determined using a neural network.

17. A computer system as in claim 15, wherein the imaging device captures the image data from the vehicle.

18. A computer system as in claim 15, wherein detecting, by the computing device, the vehicle has entered a parking scene based on the received image data further comprises:
program instructions to detect, by the computing device, surroundings of the vehicle using the imaging device associated with the vehicle.

19. A computer system as in claim 15, further comprising:
program instructions to determine, by the computing device, the vehicle is parking based on the received sensor data associated with the vehicle; and
program instructions to identify, by the computing device, a parking location of the vehicle based on the received image data associated with the vehicle.

20. A computer system as in claim 19, further comprising:
program instructions to receive, by a computing device, image data associated with the identified parking location of the vehicle from an imaging device associated with a vehicle;
program instructions to detect, by the computing device, surroundings of the identified parking location of the vehicle using the imaging device associated with the vehicle; and
program instructions to generate, by the computing device, a notification to a user associated with the vehicle, wherein the notification identifies the parking location of the vehicle.
